(19) United States
(12) Patent Application Publication
(10) Pub. No.: US 2004/0191745 A1
(43) Pub. Date: Sep. 30, 2004

(54) Learning program and recording medium

(75) Inventors: Kosei Takano, Tokyo (JP); Hiroshi Kuzumaki, Tokyo (JP); Tomotaka Ono, Kawasaki (JP); Kazuaki Honda, Tokyo (JP); Hiroshi Inagawa, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 10/781,654

(22) Filed: Feb. 20, 2004

(30) Foreign Application Priority Data
Mar. 25, 2003 (JP) 2003-082933

(51) Int. Cl. G06F 7/00

(52) U.S. Cl. 434/322

(57) ABSTRACT

A learning program whereby the degree of improvement in transaction work as a result of transaction learning can be confirmed. A work amount storage section receives an amount of transaction work which an employee has performed using a terminal, and stores the work amount in a work amount storage database (DB). In response to a request for transaction learning from the employee, a transaction learning display section displays a learning screen for the transaction learning on the terminal. A learning information storage section receives start and end times of the employee's transaction learning from the terminal, and stores the received times in a learning information storage DB. A working efficiency calculation section looks up the work amount storage DB and the learning information storage DB and, based on the work amount before the start time of the employee's transaction learning and the work amount after the end time of the learning, calculates the efficiency of the work performed after the end time of the transaction learning relative to that performed before the start time of the learning. In response to a request from a supervisor using a different terminal, the working efficiency calculation section displays the calculated working efficiency on the supervisor's terminal.

### BACKGROUND OF THE INVENTION

(1) Field of the Invention

The present invention relates to a learning program and a recording medium, and more particularly, to a learning program enabling employees of a company to learn about business transactions and to a recording medium recording the program.

(2) Description of the Related Art

It has been customary to call company's employees together in one place when conducting a training. Such training is, however, wasteful because it requires time for travel as well as transportation costs. Thus, e-learning has been proposed whereby employees can receive training (learning) from terminal devices on their own desks.

As a method of judging the degree of understanding of an e-learning trainee, an education method has been proposed in which an examination is conducted after the learning via a network and the results of the examination are used as data for judging the degree of understanding (see Japanese Unexamined Patent Publication No. 2002-116683 (page 13; FIG. 1), for example).

For a company having its employees trained, however, improvement in the transaction work as a result of the learning, compared with the transaction work before the learning, is more important than the degree of the employees' understanding.

### SUMMARY OF THE INVENTION

The present invention was created in view of the above circumstances, and an object thereof is to provide a learning program whereby the improvement in transaction work as a result of transaction learning can be confirmed, and a recording medium recording the learning program.

To achieve the object, there is provided a learning program enabling a company employee to learn about transaction through a terminal device. The learning program causes a computer to perform the process of storing an amount of transaction work which the employee has performed using the terminal device, displaying a learning screen on the terminal device in response to a request for transaction learning from the employee, storing start and end times of the transaction learning which the employee has received, and calculating, from the amount of transaction work performed before the start time of the transaction learning and the amount of transaction work performed after the end time of the transaction learning, an efficiency of the transaction work performed after the end time of the transaction learning relative to the transaction work performed before the start time of the transaction learning.

Also, to achieve the above object, there is provided a computer-readable recording medium recording a learning program enabling a company employee to learn about transaction through a terminal device. The learning program recorded on the computer-readable recording medium causes the computer to perform the process of storing an amount of transaction work which the employee has performed using the terminal device, displaying a learning screen on the terminal device in response to a request for transaction learning from the employee, storing start and end times of the transaction learning which the employee has received, and calculating, from the amount of transaction work performed before the start time of the transaction learning and the amount of transaction work performed after the end time of the transaction learning, an efficiency of the transaction work performed after the end time of the transaction learning relative to the transaction work performed before the start time of the transaction learning.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principles of the present invention;

FIG. 2 is a diagram showing an exemplary configuration according to an embodiment of the present invention;

FIG. 3 is a block diagram showing a hardware configuration of a transaction server;

FIG. 4 is a functional block diagram of the transaction server;

FIG. 5 is a diagram showing an exemplary data structure of a user information DB;

FIG. 6 is a diagram showing exemplary data stored in a transaction DB;

FIG. 7 is a diagram showing an exemplary data structure of a transaction tree link TB;

FIG. 8 is a diagram showing an exemplary data structure of a teaching material link TB;

FIG. 9 is a diagram showing exemplary data stored in a teaching material DB;

FIG. 10 is a diagram showing an exemplary data structure of a work record DB;

FIG. 11 is a diagram showing an exemplary data structure of a learning history DB;

FIG. 12 is a diagram exemplifying a data structure of a learning effect log;

FIG. 13 is a diagram also exemplifying the data structure of the learning effect log;

FIG. 14 is a diagram showing an exemplary data structure of a failed teaching material count TB;

FIG. 15 is a diagram showing an exemplary data structure of a teaching material effect TB;

FIG. 16 is a diagram showing a transaction screen displayed on an employee's terminal;

FIG. 17 is a diagram showing a learning screen displayed on the employee's terminal;

FIG. 18 is a diagram showing the transaction screen displayed on the employee's terminal after exiting the learning screen;

FIG. 19 is a diagram showing a transaction selection screen displayed on a supervisor's terminal;

FIG. 20 is a diagram showing an employee-based learning effects screen displayed on the supervisor's terminal;

FIG. 21 is a diagram showing a less effective employees screen displayed on the supervisor's terminal;

FIG. 22 is a diagram showing a less effective teaching materials screen displayed on the supervisor's terminal;

FIG. 23 is a flowchart showing a process executed by the transaction server when the employee performs transaction and learns about transaction;

FIG. 24 is a first flowchart showing a process executed by the transaction server when the supervisor checks the employees' working efficiencies and the effects of teaching material contents;

FIG. 25 is a second flowchart showing the process executed by the transaction server when the supervisor checks the employees' working efficiencies and the effects of the teaching material contents;

FIG. 26 is a flowchart showing a process executed by the transaction server when employee-based effects are to be displayed on the terminal used by the supervisor;

FIG. 27 is a flowchart showing a process executed by the transaction server when less effective employees are to be displayed on the terminal used by the supervisor; and

FIG. 28 is a flowchart showing a process executed by the transaction server when less effective teaching materials are to be displayed on the terminal used by the supervisor.

### DESCRIPTION OF THE PREFERRED EMBODIMENT

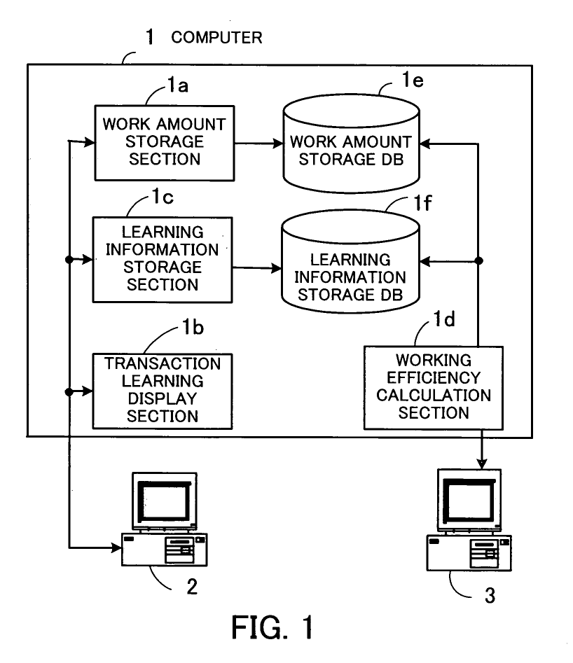

An embodiment of the present invention will be hereinafter described with reference to the drawings. FIG. 1 illustrates the principles of the present invention. As shown in the figure, a computer 1 comprises a work amount storage section 1a, a transaction learning display section 1b, a learning information storage section 1c, a working efficiency calculation section 1d, a work amount storage database (DB) 1eand a learning information storage DB 1f, all implemented by executing a learning program according to the present invention. The computer 1 is connected with a terminal device 2 which is used by a company employee to perform transactions as well as to learn about transactions, and a terminal device 3 which is used by a supervisor who supervises the transactions.

The work amount storage DB 1e is a database for storing the amount of transaction work performed by the employee. The learning information storage DB 1f is a database for storing the start and end times of transaction learning which the employee has received.

The work amount storage section 1a receives the amount of transaction work performed by the employee from the terminal 2, and stores the received work amount in the work amount storage DB 1e.

In response to a request for transaction learning from the employee, the transaction learning display section 1b displays a screen for the transaction learning on the terminal 2.

The learning information storage section 1c receives the start and end times of the employee's transaction learning from the terminal 2, and stores the received start and end times in the learning information storage DB 1f.

The working efficiency calculation section 1d looks up the work amount storage DB 1eand the learning information storage DB 1f, and calculates, from the amount of transaction work performed before the start time of the employee's transaction learning and the amount of transaction work performed after the end time of the transaction learning, an efficiency of the transaction work performed after the end time of the transaction learning relative to that performed before the start time of the learning. Then, in response to a request from the supervisor using the terminal 3, the working efficiency calculation section 1d displays the calculated working efficiency on the terminal 3.

Operation in accordance with the principles will be now described.

The work amount storage section 1a of the computer 1 stores, in the work amount storage DB 1e, the amount of transaction work which the employee has performed using the terminal 2.

The transaction learning display section 1b is responsive to a request from the employee to display the transaction learning screen on the terminal 2.

The learning information storage section 1c receives the start and end times of the employee's transaction learning from the terminal 2, and stores the received start and end times in the learning information storage DB 1f.

The working efficiency calculation section 1d looks up the work amount storage DB 1e and the learning information storage DB 1f, and calculates, from the amount of transaction work performed before the start time of the employee's transaction learning and the amount of transaction work performed after the end time of the transaction learning, the efficiency of the transaction work performed after the end time of the transaction learning relative to that performed before the start time of the learning. In response to a request from the supervisor using the terminal 3, the working efficiency calculation section 1d displays the calculated working efficiency on the terminal 3. It is therefore possible for the supervisor who supervises the transactions, that is, the company having its employees learn about transactions, to obtain information about the degree of improvement in the transaction work after the transaction learning.

In this manner, the amount of transaction work performed by the employee with the use of the terminal is stored, and also the start and end times of the employee's transaction learning are stored. Then, using the amount of transaction work performed before the start time of the employee's transaction learning and the amount of transaction work performed after the end time of the transaction learning, the efficiency of the transaction work performed after the end time of the transaction learning relative to that performed before the start time of the learning is calculated. This allows the company having its employees learn about transactions to obtain information about the degree of improvement in the transaction work as a result of the transaction learning.

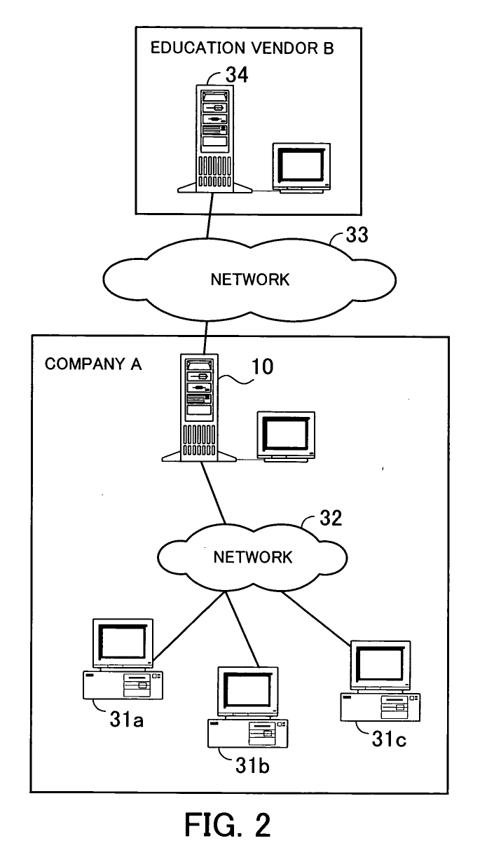

A transaction server for executing a transaction processing program according to the present invention will be now described. FIG. 2 shows an exemplary configuration according to an embodiment of the present invention. As shown in the figure, the transaction server 10 is connected with terminals 31a to 31c through a network 32. The transaction server 10 and the terminals 31a to 31c constitute a network within a company A, and the network 32 is, for example, an intranet.

The transaction server 10 is also connected through a network 33 to a server 34 which is owned by an external education vendor B. The external education vendor B provides teaching material contents for transaction learning through the network 33 in compliance with requests from various companies. The network 33 is, for example, the Internet. In the following, the system shown in FIG. 2 will be outlined.

The terminals 31a and 31b are terminal devices which employees of the company A use to perform transactions. The employees conduct transactions by having their terminals 31a and 31b display a transaction screen for performing a target transaction from among a plurality of transactions. When in doubt about transactions, the employees make a learning request to the transaction server 10 on the transaction screens on which they are performing transactions. The transaction screen is a portal site customized exclusively for the employees.

The terminal 31c is a terminal device used by a supervisor (e.g., the employees' superior) who supervises the employees' transaction work. The supervisor can access the transaction server 10 from the terminal 31c to obtain information as to whether or not the employees have progressed with the transaction work after the transaction learning.

When a learning request is received from the terminal 31a, 31b, the transaction server 10 displays, on the terminal 31a, 31b, learning content necessary to learn about the transaction of the transaction screen then displayed on the terminal 31a, 31b. Also, if teaching material content needed by an employee is not found, the transaction server 10 accesses the server 34 of the education vendor B and acquires the necessary teaching material content. Namely, whenever in doubt about a certain transaction on the transaction screen, the employees can make a learning request on that transaction screen and learn about the transaction.

Also, when a request for working efficiency calculation is received from the terminal 31c used by the supervisor, the transaction server 10 calculates the efficiency of the transaction work after the employees' learning and displays the results on the terminal 31c. Namely, the supervisor can obtain information about whether or not there is an improvement in the transaction work after the learning, compared with that before the learning.

In the illustrated example, the transaction server 10 is owned by the company A, but may be owned by a company other than the company A, for example, an external provider connected to the Internet. In this case, the terminals 31a and 31b access, via the Internet, the transaction server owned by the provider.

Although FIG. 2 shows two terminals used by the employees and a single terminal used by the supervisor, more terminals than illustrated may be provided.

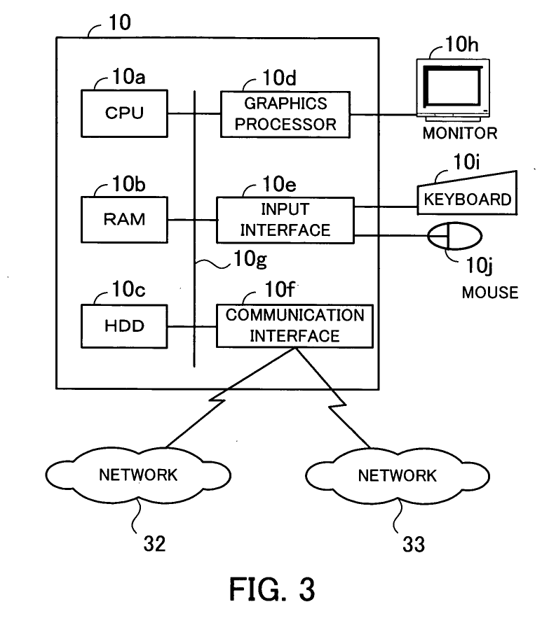

The functions of the transaction server 10 will be now described in more detail. FIG. 3 is a block diagram showing a hardware configuration of the transaction server. The transaction server 10 shown in the figure is in its entirety under the control of a CPU (Central Processing Unit) 10a. The CPU 10a is connected, via a bus 10g, with a RAM (Random Access Memory) 10b, a hard disk drive (HDD) 10c, a graphics processor 10d, an input interface 10e, and a communication interface 10f.

The RAM 10b temporarily stores OS (Operating System) programs executed by the CPU 10a and at least part of application programs. Also, the RAM 10b stores various data necessary for the processing by the CPU 10a. The HDD 10c stores the OS and application programs.

The graphics processor 10d is connected with a monitor 10h. In accordance with instructions from the CPU 10a, the graphics processor 10d displays images on the display screen of the monitor 10h. The input interface 10e is connected with a keyboard 10i and a mouse 10j. The input interface 10e sends signals from the keyboard 10i and the mouse 10j to the CPU 10a via the bus 10g.

The communication interface 10f is connected to the networks 32 and 33. The communication interface 10f communicates with the terminals 31a to 31c in the company through the network 32, and also communicates with the server 34 of the education vendor B through the network 33.

Each of the terminals 31a to 31c also has a hardware configuration similar to that shown in FIG. 3.

Processing functions of the embodiment can be performed by the hardware configuration described above.

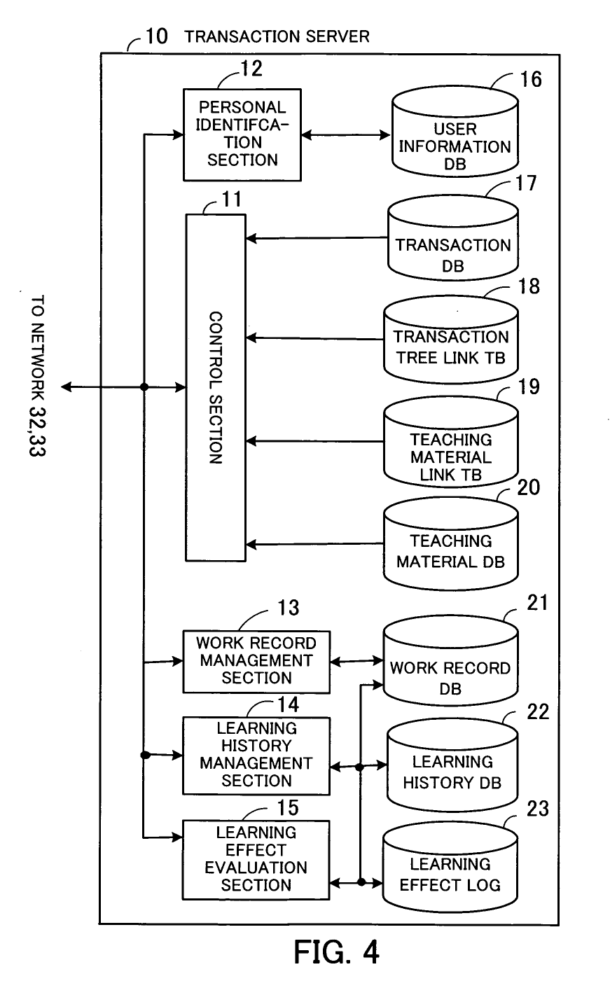

FIG. 4 is a functional block diagram of the transaction server. As shown in the figure, the transaction server 10 has a control section 11, a personal identification section 12, a work record management section 13, a learning history management section 14, a learning effect evaluation section 15, a user information database (DB) 16, a transaction DB 17, a transaction tree link table (TB) 18, a teaching material link TB 19, a teaching material DB 20, a work record DB 21, a learning history DB 22, and a learning effect log 23.

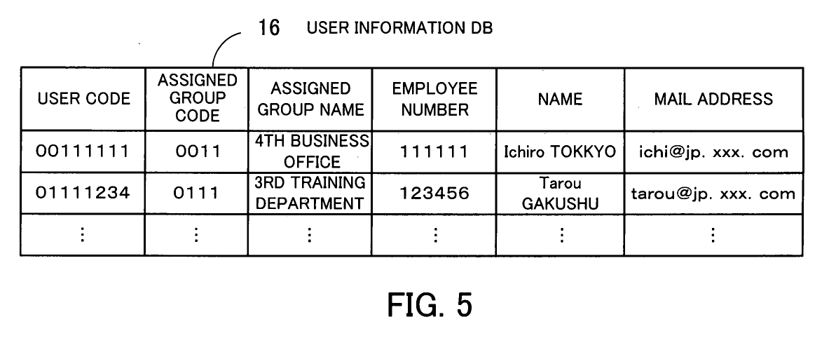

First, exemplary data structures of the databases and data tables will be explained. The user information DB 16 is a database in which is stored in advance information about the employees and the supervisor using the terminals 31a to 31c, respectively. FIG. 5 shows an exemplary data structure of the user information DB. As shown in the figure, the user information DB 16 has columns labeled “User Code”, “Assigned Group Code”, “Assigned Group Name”, “Employee No.”, “Name”, and “Mail Address”.

In the column “User Code”, the identification numbers assigned to the employees and the supervisor using the respective terminals 31a to 31c are stored. In the column “Assigned Group Code” are stored the identification numbers assigned to groups in the company A to which the employees and the supervisor belong, and in the column “Assigned Group Name” are stored the names of the groups in the company A to which the employees and the supervisor belong. In the column “Employee No.”, the employee numbers assigned to the employees and the supervisor by the company A are stored, and in the column “Name”, the names of the employees and supervisor are stored. In the column “Mail Address” are stored the mail addresses of the employees and supervisor.

In the example of FIG. 5, “Ichirou Tokkyo” is stored in the user information DB 16 as an employee's name. For “Ichirou Tokkyo”, “00111111” is stored as the user code, “0011” as the assigned group code, “4th Business Office” as the assigned group name, “111111” as the employee number, and “ichi@jp.xxx.com” as the mail address.

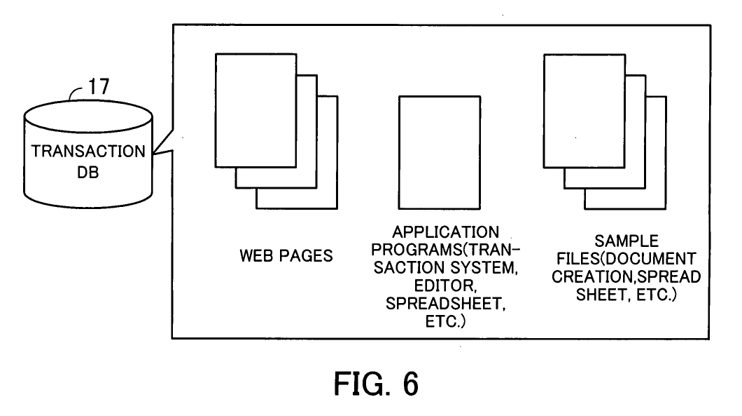

The transaction DB 17 is a database which holds data of Web pages displayed on the screens of the terminals 31a to 31c, an application program for performing transactions, and sample files showing examples of how data is to be entered when conducting transactions. FIG. 6 shows exemplary data stored in the transaction DB. As illustrated, the transaction DB 17 stores Web page data for displaying, on the terminals 31a to 31c, screens suited to transactions to be conducted. Also, the transaction DB 17 stores an application program (transaction system) for processing transactions, for example. The transaction processing program carries out, for example, processes such as file search, sending/receiving of mail, placement of transaction-related orders, and calculation of earnings and expenses. The transaction DB 17 further stores an editor for creating business proposals, and a spreadsheet application program for entering amounts of earnings and expenses. Moreover, the transaction DB 17 stores sample files showing samples of proposals and examples of how to enter amounts in the spreadsheet.

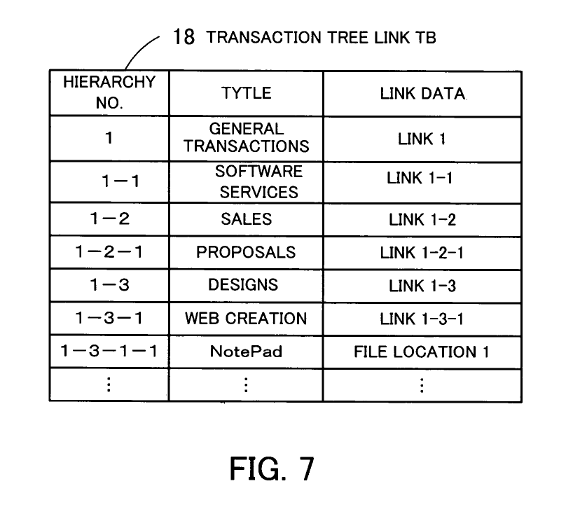

The transaction tree link TB 18 is a table showing the hierarchy of transactions. FIG. 7 shows an exemplary data structure of the transaction tree link TB. As shown in the figure, the transaction tree link TB 18 has columns labeled “Hierarchy No.”, “Title”, and “Link Data”.

In the column “Hierarchy No.” are stored the hierarchy numbers assigned to the respective items of transactions. FIG. 7 indicates that the more hyphens the hierarchy number includes as separators, the deeper in the hierarchy the corresponding transaction is. In the column “Title” are stored the titles of the data stored in the transaction DB 17, that is, the titles of the Web pages showing transaction screens, the titles of the applications which the employees can use for transactions, and the titles of the sample files of, for example, proposals which the employees can use for reference. In the column “Link Data” are stored the link data showing the locations of the Web pages, applications and sample files indicated by the respective titles. The link data is described in the form of URL (Uniform Resource Locator), for example. The hierarchy numbers are associated also with the respective transaction screens displayed on the terminals 31a to 31c and serve as identifiers of the respective transaction screens.

In the example of FIG. 7, “General Transactions” is at the highest level in the hierarchy of transaction items, and “Software Services”, “Sales” and “Designs” are at an immediately lower level than “General Transactions”. “Proposals” is at a level immediately lower than “Sales”. “Web Creation” is at a level immediately lower than “Designs”, and “NotePad”, which is an editor for entering text, is at a level immediately lower than “Web Creation”.

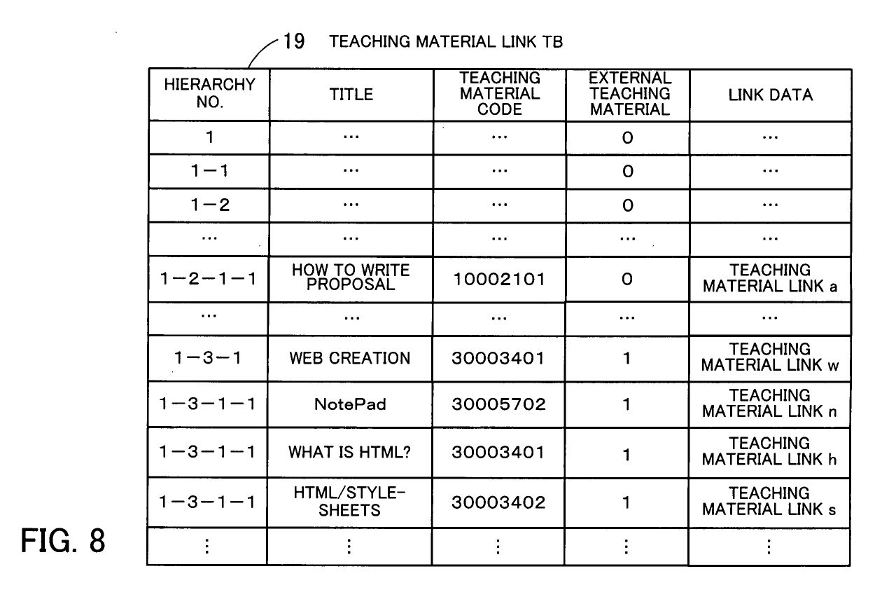

The teaching material link TB 19 is a table showing link destinations of teaching material contents by means of which the employees learn about transactions. FIG. 8 shows an exemplary data structure of the teaching material link TB. As shown in the figure, the teaching material link TB 19 has columns labeled “Hierarchy No.”, “Title”, “Teaching Material Code”, “External Teaching Material”, and “Link Data”.

In the column “Hierarchy No.”, the hierarchy numbers corresponding to those in the transaction tree link TB 18 are stored, and in the column “Title”, the titles of teaching material contents are stored. In the column “Teaching Material Code” are stored the identification numbers identifying the respective teaching material contents. In the column “External Teaching Material”, an identifier is stored which specifies whether the corresponding teaching material content is stored in the teaching material DB 20 or in the server 34 of the external education vendor B. In FIG. 8, the external teaching material “0” indicates that the teaching material content is stored in the teaching material DB 20, and the external teaching material “1” indicates that the teaching material content is stored in the server 34 of the external education vendor B. In the column “Link Data” are stored the link data showing locations where the teaching material contents are stored. The link data is described in the form of, for example, URL.

In the example of FIG. 8, the title corresponding to the hierarchy number “1-3-1” is “Web Creation”, and the teaching material code of the title “Web Creation” is “30003401”. In the column “External Teaching Material”, “1” is set, indicating that the teaching material content with the title “Web Creation” is stored in the server 34 of the external education vendor B. Also, “Teaching Material Link w” is stored as the link data.

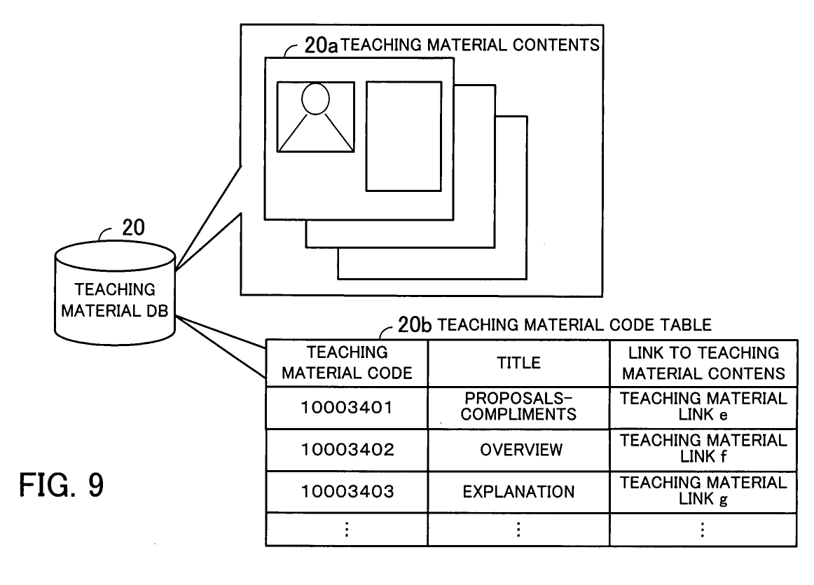

The teaching material DB 20 is a database in which are stored teaching material contents allowing the employees to learn about transactions. FIG. 9 shows exemplary data stored in the teaching material DB. As shown in the figure, the teaching material DB 20 stores teaching material contents 20a, which are the entities of the teaching material contents, and a teaching material code table 20b. The teaching material code table 20b has columns labeled “Teaching Material Code”, “Title”, and “Link to Teaching Material Content”.

In the column “Teaching Material Code”, the identification numbers identifying the respective teaching material contents 20a are stored. In the column “Title” are stored the titles of the teaching material contents 20a, and in the column “Link to Teaching Material Content” are stored the locations where the teaching material contents 20a are stored. The locations of the teaching material contents 20a are described in the form of URL, for example.

As mentioned above, the hierarchy numbers in the teaching material link TB 19 correspond to those in the transaction tree link TB 18 shown in FIG. 7. Accordingly, when a “Learn” button is pressed on the transaction screen displayed on the terminal 31a, 31b, for example, the title of teaching material content with the corresponding hierarchy number is retrieved from the teaching material link TB 19 and displayed (a plurality of titles are displayed if there are multiple applicable contents). Then, if the title is selected by clicking, for example, the link data is looked up and the corresponding teaching material content is displayed on screen.

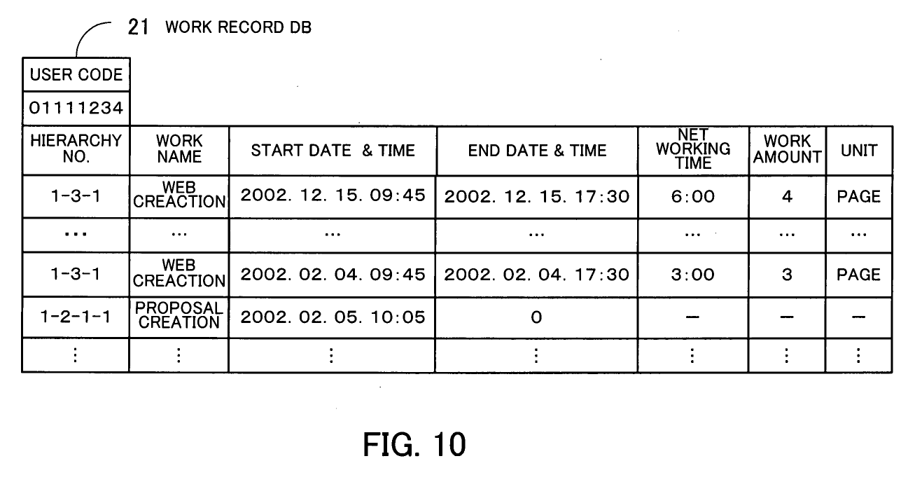

The work record DB 21 is a database holding information about the transaction work carried out by the employees. FIG. 10 shows an exemplary data structure of the work record DB. As shown in the figure, the work record DB 21 has columns labeled “User Code”, “Hierarchy No.”, “Work Name”, “Start Date & Time”, “End Date & Time”, “Net Working Time”, “Work Amount”, and “Unit”. In the work record DB 21, each user code (each employee) is provided with the columns “Hierarchy No.”, “Work Name”, “Start Date & Time”, “End Date & Time”, “Net Working Time”, “Work Amount”and “Unit”.

In the column “User Code”, the identification number assigned to an employee who performs transactions is stored. In the column “Hierarchy No.” are stored the hierarchy numbers of transactions conducted by the employee, and in the column “Work Name” are stored the work names of the transactions performed by the employee. In the column “Start Date & Time” are stored the dates and times when the transactions were started, and in the column “End Date & Time” are stored the dates and times when the transactions were finished. In the column “Net Working Time”, the net working times actually spent on the transactions are stored. In the column “Work Amount”, the amounts of products obtained by conducting the transactions are stored. For example, the number of Web pages or of pages of a proposal produced as a result of the transaction is stored as the work amount. In the column “Unit” is stored the unit for the amount of transaction work performed by the employee.

The example shown in FIG. 10 indicates that the employee with the user code “01111234” started transaction with the work name “Web Creation” at 9:45 of Dec. 15, 2002 on the transaction screen with the hierarchy number “1-3-1”. It also shows that the employee with the user code “01111234” ended the transaction with the work name “Web Creation” at 17:30 of Dec. 15, 2002 and spent a full six hours on the work with the work name “Web Creation”. The illustrated example further indicates that the amount of work with the work name “Web Creation”, performed by the employee with the user code “01111234”, is “4” and that one Web page is used as the unit for measuring the amount of work with the work name “Web Creation”.

Moreover, the example of FIG. 10 shows that the employee with the user code “01111234” started transaction with the work name “Proposal Creation” at 10:05 of Feb. 5, 2002 on the transaction screen with the hierarchy number “1-2-1-1”. The employee with the user code “01111234” has not yet finished the transaction with the work name “Proposal Creation”, so that the value “0” is set in the column “End Date & Time”. Thus, no data is stored in the columns “Net Working Time”, “Work Amount” and “Unit”.

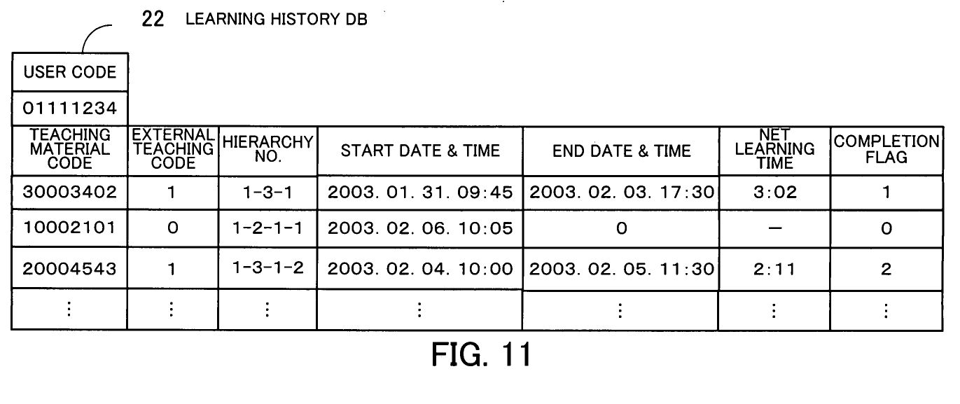

The learning history DB 22 stores historical information about the employees' past learning. FIG. 11 shows an exemplary data structure of the learning history DB. As shown in the figure, the learning history DB 22 has columns labeled “User Code”, “Teaching Material Code”, “External Teaching Material”, “Hierarchy No.”, “Start Date & Time”, “End Date & Time”, “Net Learning Time”, and “Completion Flag”. In the learning history DB 22, each user code (each employee) is provided with the columns “Teaching Material Code”, “External Teaching Material”, “Hierarchy No.”, “Start Date & Time”, “End Date & Time”, “Net Learning Time”, and “Completion Flag”.

In the column “User Code”, the identification number assigned to an employee who learned about transaction is stored. In the column “Teaching Material Code” are stored the identification numbers of the teaching material contents which the employee has used for learning. In the column “External Teaching Material” is stored an identifier indicating whether the corresponding teaching material content was stored in the teaching material DB 20 or in the server 34 of the external education vendor B. In the column “Hierarchy No.” are stored the hierarchy numbers of the transaction screens which had been displayed when the employee made a learning request. In the column “Start Date & Time” are stored the dates and times when the employee started learning, and in the column “End Date & Time” are stored the dates and times when the employee finished the learning. In the column “Net Learning Time” are stored the times which the employee actually spent on the learning, and in the column “Completion Flag” is stored information indicating whether or not the learning is completed and whether or not the learning effect log 23 has been created (described in detail later). In FIG. 11, the completion flag “0” indicates that the learning is not completed yet, the completion flag “1” indicates that the learning is completed, and the completion flag “2” indicates that the learning effect log 23 has been created.

The example of FIG. 11 shows that the employee with the user code “01111234” has completed learning of the teaching material content with the teaching material code “30003402”, as seen from the value “1” set in the column “Completion Flag”. It also indicates that the teaching material content with the teaching material code “30003402” had been stored in the server 34 of the external education vendor B and that the hierarchy number of the transaction screen on which a learning request was made was “1-3-1”. The illustrated example further shows that the learning was started at 9:45 of Jan. 31, 2003 and finished at 17:30 of Feb. 3, 2003, and that the net learning time spent on the learning of the teaching material content with the teaching material code “30003402” was 3 hours and 2 minutes.

Also, the employee with the user code “01111234” is still in the middle of learning the teaching material content with the teaching material code “10002101”, as seen from the value “0” set in the column “Completion Flag”. Further, as indicated by the value “2” set in the column “Completion Flag”, the employee with the user code “01111234” has completed the learning of the teaching material content with the teaching material code “20004543” and the learning effect log 23 has been created.

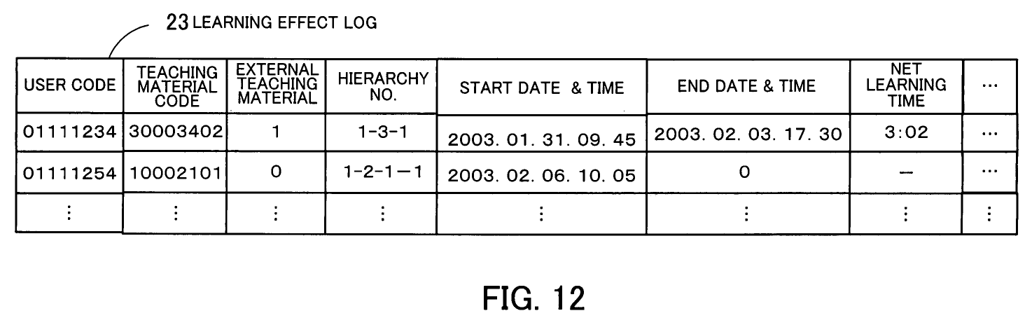

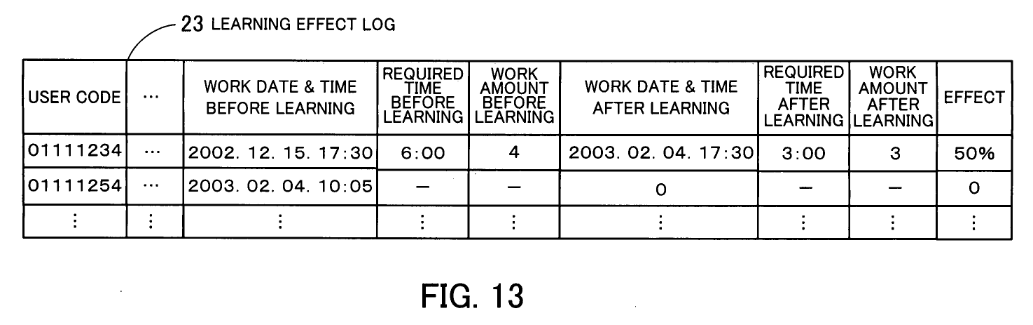

The learning effect log 23 is a log file which is generated at the request of the supervisor and which shows the effects of transaction learning on the employees. FIGS. 12 and 13 show an exemplary data structure of the learning effect log. The parts shown in FIGS. 12 and 13 constitute one learning effect log 23. As shown in the figures, the learning effect log 23 has columns labeled “User Code”, “Teaching Material Code”, “External Teaching Material”, “Hierarchy No.”, “Start Date & Time”, “End Date & Time”, “Net Learning Time”, “Work Date & Time Before Learning”, “Required Time Before Learning”, “Work Amount Before Learning”, “Work Date & Time After Learning”, “Required Time After Learning”, “Work Amount After Learning”, and “Effect”.

In the column “User Code”, the identification numbers assigned to the employees who have learned about transactions are stored. In the column “Teaching Material Code”, the identification numbers identifying the teaching material contents used by the employees for learning are stored, and in the column “External Teaching Material”, an identifier is stored which specifies whether the corresponding teaching material content had been stored in the teaching material DB 20 or in the server 34 of the external education vendor B. In the column “Hierarchy No.” are stored the hierarchy numbers of the transaction screens on which the employees made a learning request. In the column “Start Date & Time” are stored the dates and times when the learning was started, and in the column “End Date & Time” are stored the dates and times when the learning was finished. In the column “Net Learning Time” are stored the times which the employees spent on the learning. In the column “Work Date & Time Before Learning” are stored the date and time when transaction work, which is the target of the corresponding learning, was performed by the employee immediately before the learning. In the column “Required Time Before Learning” is stored the time required for the transaction work performed by the employee immediately before the learning. In the column “Work Date & Time After Learning” are stored the date and time when transaction work, which is the target of the corresponding learning, was performed by the employee immediately after the learning. In the column “Required Time After Learning” is stored the time required for the transaction work performed by the employee immediately after the learning. In the column “Work Amount After Learning” is stored the amount of the transaction work performed-by the employee immediately after the learning. In the column “Effect” is stored the efficiency of the transaction work performed after the learning relative to that performed before the learning.

The example shown in FIGS. 12 and 13 indicates that the employee with the user code “01111234” has learned the teaching material content with the teaching material code “30003402”, which is external teaching material. It also shows that the learning request for the teaching material content with the teaching material code “30003402” was made on the transaction screen with the hierarchy number “1-3-1”. The learning of the teaching material content with the teaching material code “30003402” was started at 9:45 of Jan. 31, 2003 and finished at 17:30 of Feb. 3, 2003. Also, the net learning time for the teaching material content with the teaching material code “30003402” was 3 hours and 2 minutes.

The illustrated example further shows that the transaction work performed by the employee with the user code “01111234” before the learning on the transaction screen with the hierarchy number “1-3-1” was started at 17:30 of Dec. 15, 2002, that the work required 6 hours, and that the work amount was “4”.

Also, the illustrated example indicates that the transaction work performed by the employee with the user code “01111234” after the learning on the transaction screen with the hierarchy number “1-3-1” was started at 17:30 of Feb. 4, 2003, that the work required 3 hours, and that the work amount was “3”. As a result of the learning of the teaching material content with the teaching material code “30003402”, the efficiency of work on the transaction screen with the hierarchy number “1-3-1” increased by 50%.

The control section 11 displays the items of transactions in hierarchical form on part of the screen of each of the terminals 31a to 31c, to allow the employees and the supervisor to optionally select transactions through drill-down and drill-up. The transaction items displayed in hierarchical form are associated with respective hierarchy numbers appearing in the transaction tree link TB 18 shown in FIG. 7. When a transaction item is selected at any of the terminals 31a to 31c, the control section 11 looks up the link data in the transaction tree link TB 18 corresponding to the hierarchy number of the selected transaction item. Then, following the link data, the control section 11 acquires the applicable Web page data, application program and sample file stored in the transaction DB 17, displays the Web page and the sample file on the corresponding one of the terminals 31a to 31c, and also sets the application program ready for execution.

Also, when a learning request is received from an employee, the control section 11 looks up the titles in the teaching material link TB 19 corresponding to the hierarchy number of the transaction screen (transaction item) then displayed on the terminal 31a, 31b and displays the titles. On selection of a title, the control section 11 looks up the corresponding link data in the teaching material link TB 19. Then, following the link data, the control section 11 acquires the corresponding teaching material content stored in the teaching material DB 20, to permit the employee to learn about the transaction on the terminal 31a, 31b. If desired teaching material content is not found among the displayed titles, a search is performed using a keyword, and if the teaching material content does not exist in the teaching material DB 20, the control section 11 acquires the content from the server 34 of the external education vendor B. Accordingly, by simply making a learning request while performing transaction on the terminal 31a, 31b, the employee can learn about the transaction he/she is conducting. To this end, the control section 11 displays, on each of the terminals 31a to 31c, a button which permits the employees, for example, to make a learning request.

The personal identification section 12 performs a process of authenticating the employees and the supervisor at the start of transaction. When starting transaction, the employees and the supervisor enter their user codes and names, for example, from the terminals 31a to 31c. The personal identification section 12 receives the user codes and names input from the terminals 31a to 31c, and compares the input user codes and names with those stored in the user information DB 16 to determine whether they coincide or not.

The work record management section 13 stores information about the transaction work performed by the employees in the work record DB 21. The work record management section 13 manages the transaction work information for the individual employees. Specifically, the work record management section 13 acquires the hierarchy numbers from the transaction screens on which the employees worked, and stores the work names of the transactions performed by the employees in the work record DB 21. Also, the work record management section 13 stores, in the work record DB 21, the dates and times when the employees started their transactions, the dates and times when the transactions were finished, the net working times spent to complete the transactions, the work amounts, and the units of the transactions performed by the employees.

The learning history management section 14 stores historical information about the employees' past learning in the learning history DB 22. The learning history management section 14 manages the learning history information for the individual employees. Specifically, the learning history management section 14 acquires the hierarchy numbers of the transaction screens on which the employees made a learning request, and stores the acquired hierarchy numbers in the learning history DB 22. Also, the learning history management section 14 stores, in the learning history DB 22, the teaching material codes of the teaching material contents which the employees used for learning, and information indicating whether the teaching material contents were acquired from the teaching material DB 20 or from the server 34 of the external education vendor B. Further, the learning history management section 14 stores, in the learning history DB 22, the dates and times when the employees started their learning, the dates and times when the learning was finished, and the net learning times spent on the learning. If an employee is still in the middle of learning and thus the learning is not finished, the learning history management section 14 stores the completion flag “0” in the learning history DB 22. For employees who finished their learning, the learning history management section 14 stores the completion flag “1” in the learning history DB 22.

In response to a request from the supervisor, the learning effect evaluation section 15 calculates the efficiency of each employee's transaction work performed after the learning relative to that performed before the learning and generates the learning effect log 23. Specifically, the learning effect evaluation section 15 acquires, from the learning history DB 22, the hierarchy number, start date and time, and end date and time with respect to which “1” is set as the completion flag. Then, the learning effect evaluation section 15 acquires, from the work record DB 21, the hierarchy number of completed transaction work of which the hierarchy number is identical with that acquired from the learning history DB 22 and which was completed later than and at the same time nearest to the end date and time acquired from the learning history DB 22. Further, the learning effect evaluation section 15 acquires, from the work record DB 21, the hierarchy number of completed transaction work of which the hierarchy number is identical with that acquired from the learning history DB 22 and which was completed earlier than and at the same time nearest to the start date and time acquired from the learning history DB 22. Namely, the learning effect evaluation section 15 acquires, from the work record DB 21, information about the transaction work completed by the employee immediately before the learning and information about the transaction work completed immediately after the learning. Then, the learning effect evaluation section 15 generates the learning effect log 23 based on the transaction work information acquired as mentioned above and information from the learning history DB 22 and the work record DB 21.

When generating the learning effect log 23, the learning effect evaluation section 15 calculates the efficiency of the transaction work performed after the learning relative to that performed before the learning, which efficiency is to be stored in the column “Effect”. Specifically, the learning effect evaluation section 15 first calculates the work amount performed per unit time before the learning and the work amount performed per unit time after the learning. Then, the learning effect evaluation section 15 subtracts the work amount performed per unit time before the learning from the work amount performed per unit time after the learning, and divides the obtained difference by the work amount performed per unit time before the learning, to obtain the working efficiency. The learning effect evaluation section 15 stores the calculated working efficiency in the column “Effect” of the learning effect log 23. The work amount per unit time is a value obtained by dividing the work amount by the net working time, and the unit thereof is “work amount/h”.

Also, the learning effect evaluation section 15 picks out information about the learning effects of an employee specified by the supervisor from the learning effect log 23 and displays the information on the terminal 31c. Specifically, the learning effect evaluation section 15 receives the user code of a desired employee from the supervisor and acquires the learning effect information associated with the received user code from the learning effect log 23. Then, the learning effect evaluation section 15 sorts the acquired teaching material contents in ascending order of learning effect of the selected employee, and displays the results on the terminal 31c.

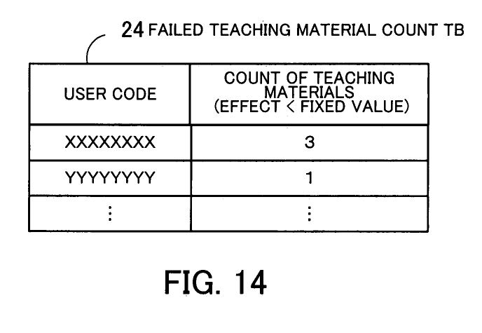

Further, at the request of the supervisor, the learning effect evaluation section 15 picks out employees showing less learning effects from the generated learning effect log 23 and displays the employees on the terminal 31c. Specifically, the evaluation section 15 sorts the learning effect log 23 according to user codes, and counts, for each user code of the log 23, the number of teaching material codes of teaching materials of which the effects are not higher than a predetermined value, to create a failed teaching material count table (TB). FIG. 14 shows an exemplary data structure of the failed teaching material count TB. As shown in the figure, the failed teaching material count TB 24 has columns labeled “User Code” and “Count of Teaching Materials (Effect<Fixed Value)”. In the column “User Code” are stored the user codes of employees who learned about transactions, and in the column “Count of Teaching Materials (Effect<Fixed Value)” are stored the counts of teaching materials of which the effects in the learning effect log 23 are not higher than the predetermined value. After generating the failed teaching material count TB 24, the learning effect evaluation section 15 sorts the failed teaching material count TB 24 in descending order of the count of teaching materials whose effects are not higher than the fixed value, and displays, while looking up the failed teaching material count TB 24 thus sorted, the employees on the terminal 31c in descending order of the count of failed teaching materials.

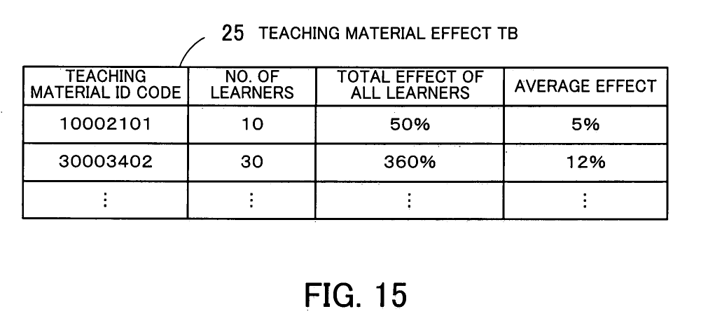

Moreover, at the request of the supervisor, the learning effect evaluation section 15 picks out teaching material contents showing less learning effects from the learning effect log 23 and displays the contents on the terminal 31c. Specifically, the evaluation section 15 sorts the learning effect log 23 according to teaching material codes, and obtains, for each teaching material code, an average effect, to create a teaching material effect table (TB). FIG. 15 shows an exemplary data structure of the teaching material effect TB. As shown in the figure, the teaching material effect TB 25 has columns labeled “Teaching Material ID Code”, “No. of Learners”, “Total Effect of All Learners”, and “Average Effect”. In the column “Teaching Material ID Code” are stored the teaching material codes stored in the learning effect log 23. In the column “No. of Learners” are stored the numbers of learners who learned the respective teaching material contents, and in the column “Total Effect of All Learners” are stored totals of effects of all learners who learned the respective teaching material contents. In the column “Average Effect” are stored values obtained by dividing the total effects of all learners by the respective numbers of learners. After generating the teaching material effect TB 25, the learning effect evaluation section 15 sorts the teaching material effect TB 25 in ascending order of the average effect, and displays, while looking up the teaching material effect TB 25 thus sorted, teaching material contents of which the average effects are lower than a predetermined value, on the terminal 31c in ascending order of the average effect.

In the following, exemplary screens displayed on the terminals 31a and 31b used by the employees will be described.

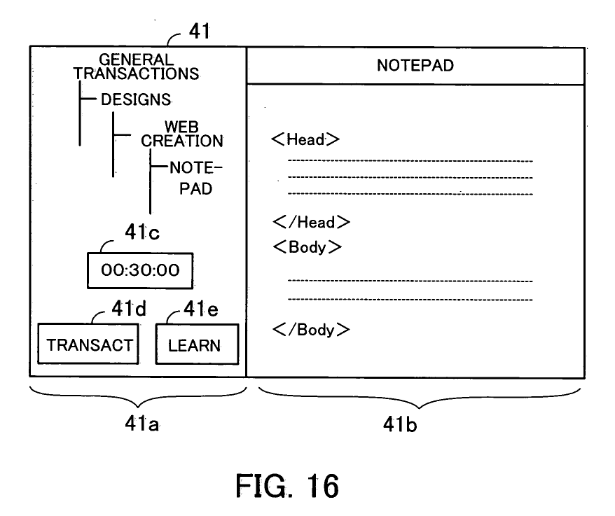

FIG. 16 shows a transaction screen displayed on the employee's terminal. As shown in the figure, the screen 41 of the terminal 31a, 31b used by the employee is split into areas 41a and 41b. The area 41a shows transaction items in hierarchical form, and the area 41b shows a transaction screen for conducting transaction. In the area 41a, “General Transactions”, “Designs”, which is lower in hierarchical level than “General Transactions”, and “Web Creation”, which is lower in hierarchical level than “Designs”, are displayed in hierarchical form.

Also, the area 41a includes a time display section 41c in which is displayed the time the employee has spent in performing transaction on the transaction screen concerned, a button 41d labeled “Transact”, and a button 41e labeled “Learn”.

The transaction items displayed in hierarchical form drill up and down when, for example, the employee double-clicks the mouse of the terminal 31a, 31b. With the mouse pointer positioned over a transaction item, the employer double-clicks the transaction item, whereupon the employee can perform the transaction displayed in the area 41b. At this time, the time display section 41c starts to measure the elapsed time. Also, clicking the mouse with the pointer positioned over the button 41e permits the employee to learn about the transaction.

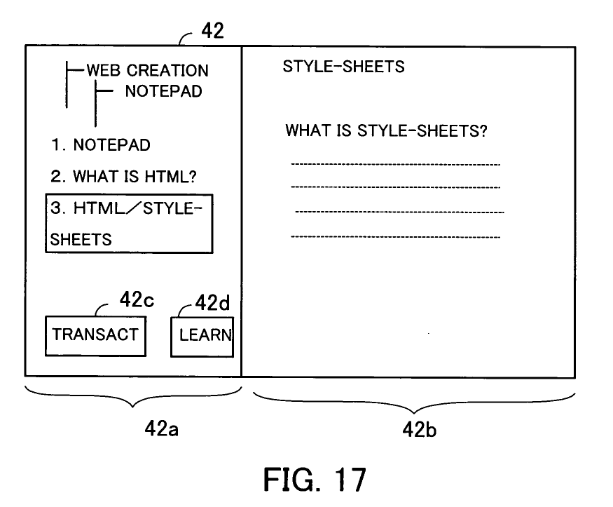

FIG. 17 shows a learning screen displayed on the employee's terminal. The screen 42, which appears as soon as the button 41e is clicked on the screen shown in FIG. 16, is split into areas 42a and 42b. The area 42a shows learning items for learning about HTML (Hyper Text Markup Language), as well as buttons 42c and 42d labeled “Transact” and “Learn”, respectively.

On the screen 42, the mouse is double-clicked with the pointer positioned over a learning item, whereupon the teaching material content corresponding to this learning item is displayed in the area 42b. In FIG. 17, the area 42b shows a screen of the teaching material content which is displayed when the button 42d is clicked with “3. HTML/Style-sheets” in the area 42a activated. Clicking the button 42c brings the screen back to the transaction screen on which the learning request was made, that is, the transaction screen “Web Creation”.

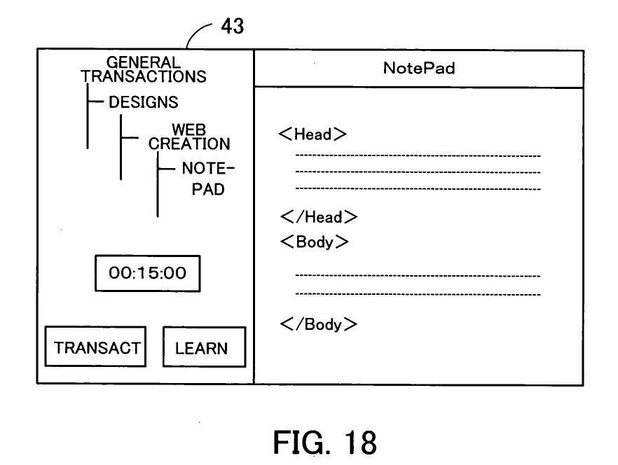

FIG. 18 shows the transaction screen displayed on the employee's terminal after exiting the learning screen. The screen 43 appears as soon as the button 42c is clicked on the screen 42 shown in FIG. 17. As illustrated, the screen 43 is the transaction screen “Web Creation” on which the learning request was made, and is identical with the screen 41 shown in FIG. 16.

Exemplary screens displayed on the terminal 31c used by the supervisor will be now described.

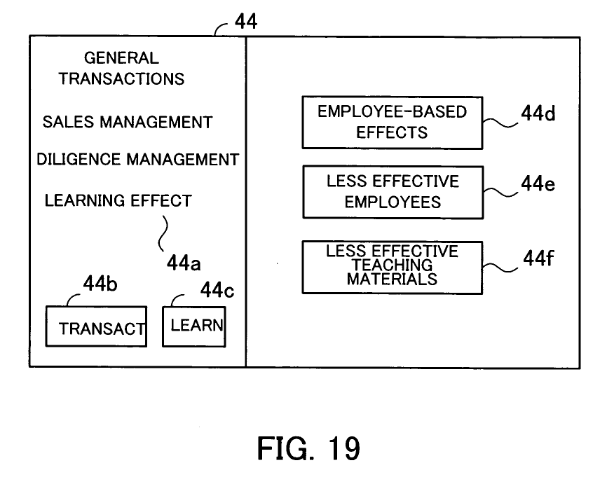

FIG. 19 shows a transaction selection screen displayed on the supervisor's terminal. As shown in the figure, the screen 44 of the terminal 31c used by the supervisor displays a text section 44a which is labeled “Learning Effect” and which allows the supervisor to view the employees' learning effects. Also, the screen 44 shows a button 44b labeled “Transact”, a button 44c labeled “Learn”, a text section 44d labeled “Employee-based Effects”, a text section 44e labeled “Less Effective Employees”, and a text section 44f labeled “Less Effective Teaching Materials”.

With the pointer of the mouse of the terminal 31c positioned over the text section 44a, the supervisor clicks the mouse to activate the text section 44a, whereupon the text sections 44d to 44f appear on the screen 44 as illustrated. Then, with one of the text sections 44d to 44f activated using the mouse, the button 44b labeled “Transact” is clicked, whereupon the screen switches to a screen showing contents corresponding to the selected one of the text sections 44d to 44f.

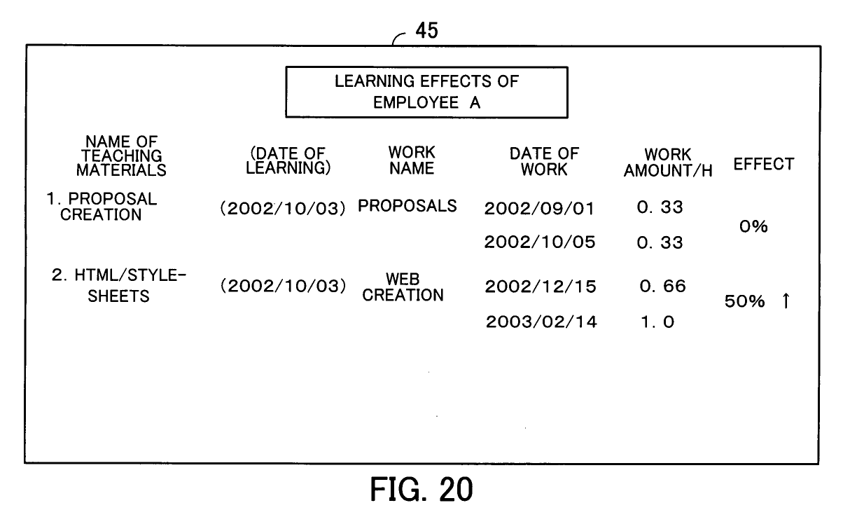

FIG. 20 shows an employee-based effects screen displayed on the supervisor's terminal. The screen 45 is a screen which is displayed as soon as the “Transact” button 44b is clicked on the screen shown in FIG. 19 with the text section “Employee-based Effects” 44d activated. As illustrated, the screen 45 shows the names of the teaching material contents which an employee has learned, the dates of learning, the work names, the dates of work, the work amounts (work amounts per unit time), and the effects. By making the screen 45 displayed on the terminal 31c, the supervisor can confirm the names of the teaching material contents which each employee has learned, as well as the degree of each employee's improvement in the transaction work.

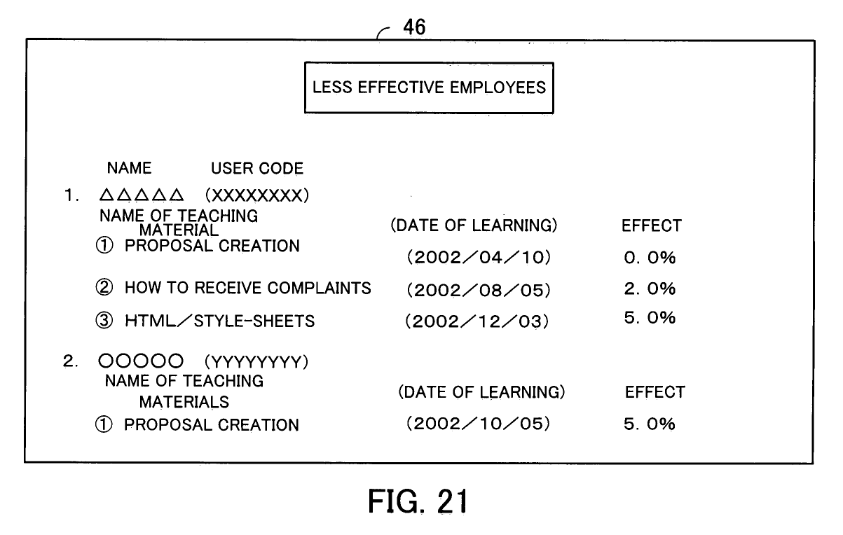

FIG. 21 shows a less effective employees screen displayed on the supervisor's terminal. The screen 46 is displayed as soon as the “Transact” button 44b is clicked on the screen shown in FIG. 19 with the text section “Less Effective Employees” 44e activated. As illustrated, the screen 46 shows the names of employees whose working efficiency did not increase much as a result of the learning, along with the user codes, teaching material names, dates of learning, and effects. The screen 46 thus displayed on the terminal 31c permits the supervisor to check the employees who showed less learning effects as a result of the learning of teaching material contents.

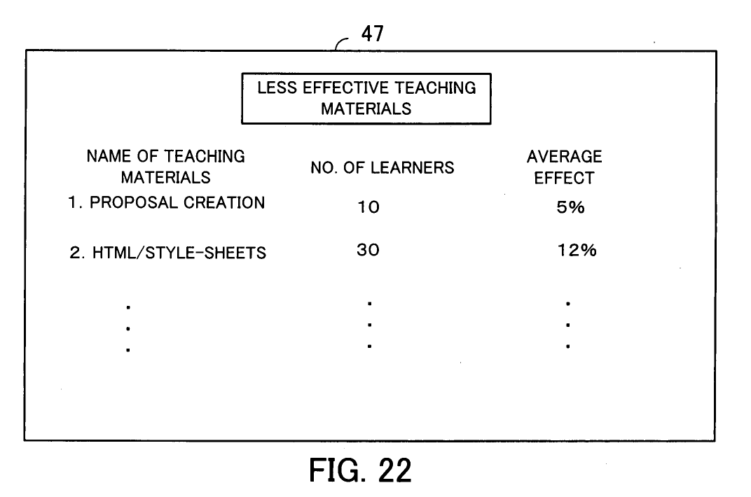

FIG. 22 shows a less effective teaching materials screen displayed on the supervisor's terminal. The screen 47 is displayed as soon as the “Transact” button 44b is clicked on the screen shown in FIG. 19 with the text section “Less Effective Teaching Materials” 44f activated. As illustrated, the screen 47 shows the names of teaching material contents which, though learned, failed to greatly increase the working efficiency, along with the numbers of learners, and average effects. The screen 47 thus displayed on the terminal 31c permits the supervisor to check the teaching material contents which had less teaching effects on the employees.

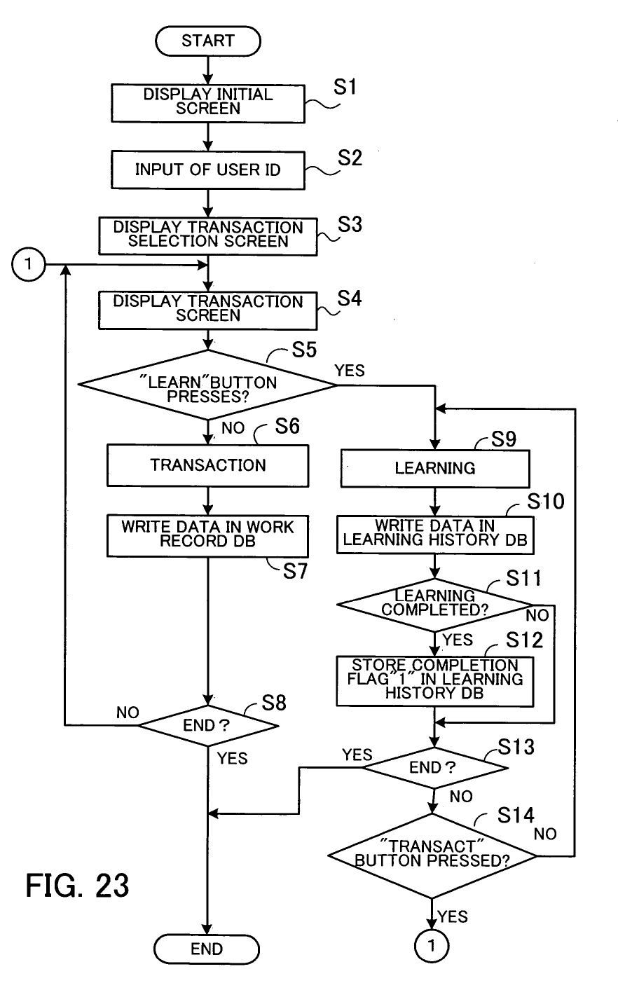

Referring now to flowcharts, operations of the transaction server 10 of FIG. 4 will be explained. FIG. 23 is a flowchart showing a process executed by the transaction server when an employee performs transaction and learns about transaction. The transaction server 10 carries out the process by executing the following steps.

[Step S1] After the employee's terminal 31a, 31b is turned on, the personal identification section 12 of the transaction server 10 displays, on the terminal 31a, 31b, an initial screen for identifying the employee.

[Step S2] The personal identification section 12 receives the employee's user code and name from the terminal 31a, 31b. The personal identification section 12 determines whether or not the received user code and name coincide with those previously stored in the user information DB 16. If the former user code and name coincide with the latter, the process proceeds to Step S3; if not, the process waits until the correct user code and name are received.

[Step S3] In response to a request from the terminal 31a, 31b, the control section 11 displays a portal site, which is an initial screen customized by the employee. The control section 11 then looks up the link data with the hierarchy number “1”, which is at the highest level in the transaction tree link TB 18, acquires the corresponding Web page data stored in the transaction DB 17, and transmits the acquired Web page data to the terminal 31a, 31b. As a result, the items of transactions to be selected are displayed on the screen of the terminal 31a, 31b in hierarchical form. The control section 11 also displays the “Learn” button for accepting the employee's learning request on the terminal 31a, 31b.

[Step S4] The control section 11 displays, on the terminal 31a, 31b, the Web page and sample file of the transaction item which the employee has selected through drill-up or drill-down. Also, the control section 11 prepares an application program corresponding to the transaction item selected by the employee so that the program can be executed.

[Step S5] The control section 11 determines whether or not the “Learn” button has been pressed (clicked) on the transaction screen of the terminal 31a, 31b. Namely, the control section 11 determines whether or not the employee has made a learning request. If it is judged that the “Learn” button is not pressed, the control section 11 proceeds to Step S6; if it is judged that the “Learn” button has been pressed, the control section 11 proceeds to Step S9.

[Step S6] The control section 11 performs transaction in accordance with instructions from the terminal 31a, 31b.

[Step S7] The work record management section 13 stores the user code of the employee who is performing transaction, the hierarchy number of the transaction (transaction screen) being performed, and the work name in the work record DB 21. Also, the work record management section 13 stores, in the work record DB 21, the date and time when the transaction work was started, the date and time when the work was finished, the net working time actually spent on the work, the work amount and the unit.

[Step S8] The control section 11 receives a response from the terminal 31a, 31b as to termination of the transaction. If the response received from the terminal 31a, 31b is that the transaction is not ended, the control section 11 proceeds to Step S4; if the response received from the terminal 31a, 31b is that the transaction is ended, the control section 11 terminates the process.

[Step S9] The control section 11 acquires the hierarchy number of the transaction screen which had been displayed on the terminal 31a, 31b when the “Learn” button was pressed. Then, the control section 11 looks up the corresponding hierarchy number in the teaching material link TB 19, acquires teaching material content specified by the link data from the teaching material DB 20 or from the server 34 of the external education vendor B, and displays the acquired teaching material content on the terminal 31a, 31b.

[Step S10] The learning history management section 14 stores, in the learning history DB 22, the user code of the employee who has requested the learning, the code of the teaching material content, information indicating whether or not the teaching material content was acquired from the external server 34, and the hierarchy number of the transaction for which the learning has been requested. Also, the learning history management section 14 stores, in the learning history DB 22, the date and time when the learning was started, the date and time when the learning was finished, and the net learning time actually spent on the learning.

[Step S11] The learning history management section 14 receives a response from the terminal 31a, 31b as to termination of the learning. If the received response is that the learning is finished, the learning history management section 14 proceeds to Step S12; if the received response is that the learning is not finished yet, the learning history management section 14 proceeds to Step S13.

[Step S12] The learning history management section 14 stores the completion flag “1”, which indicates that the learning is finished, in the learning history DB 22.

[Step S13] The control section 11 receives a response from the terminal 31a, 31b as to termination of the transaction. If the received response is that the transaction is not finished, the control section 11 proceeds to Step S14; if the received response is that the transaction is finished, the control section 11 terminates the process.

[Step S14] The control section 11 determines whether or not the “Transact” button displayed on the terminal 31a, 31b has been pressed. If the “Transact” button has been pressed, the control section 11 proceeds to Step S4; if the “Transact” button is not pressed, the control section 11 proceeds to Step S9.

In this manner, the transaction server 10 stores information about the transaction work performed by the employees in the work record DB 21, and also stores historical information about the employees' learning in the learning history DB 22.

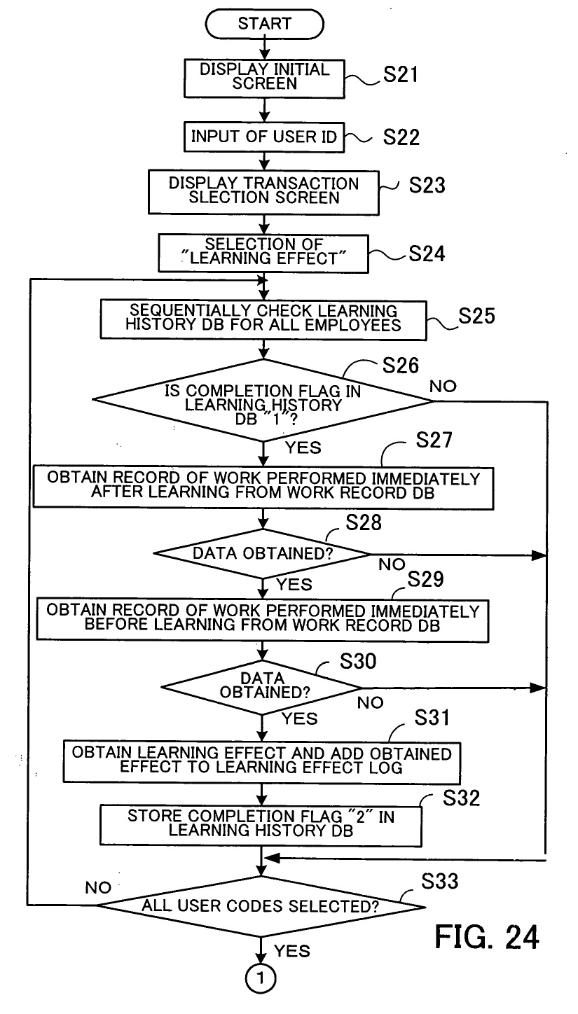

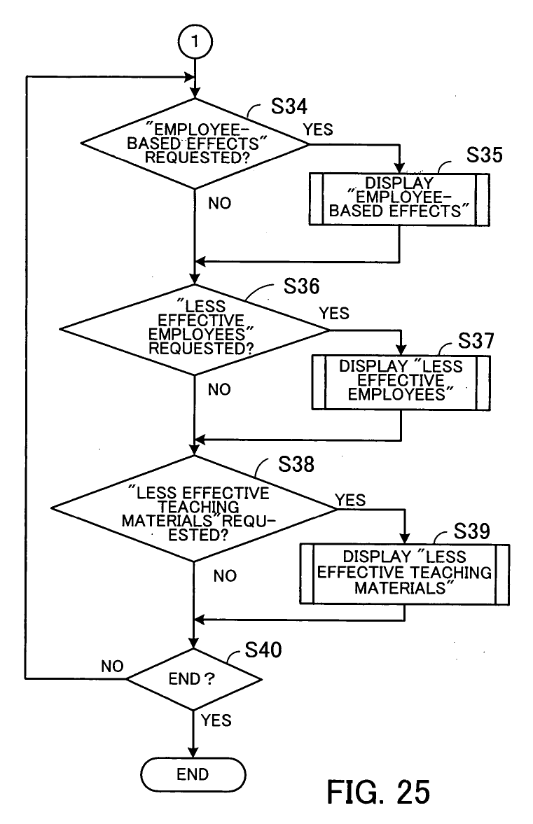

The following describes a process executed by the transaction server 10 when the supervisor checks the employees' working efficiencies etc. FIG. 24 is a first flowchart showing the process executed by the transaction server when the supervisor checks the employees' working efficiencies and the effects of the teaching material contents, and FIG. 25 is a second flowchart showing the process executed by the transaction server when the supervisor checks the employees' working efficiencies and the effects of the teaching material contents. The transaction server 10 carries out the process by executing the following steps.

[Step S21] After the supervisor's terminal 31c is turned on, the personal identification section 12 of the transaction server 10 displays, on the terminal 31c, an initial screen for identifying the supervisor.

[Step S22] The personal identification section 12 receives the supervisor's user code and name from the terminal 31c. The personal identification section 12 determines whether or not the received user code and name coincide with those previously stored in the user information DB 16. If the former user code and name coincide with the latter, the process proceeds to Step S23; if not, the process waits until the correct user code and name are received.

[Step S23] In response to a request from the terminal 31c, the control section 11 displays a portal site, which is an initial screen customized by the supervisor. The control section 11 shows the items of transactions to be selected, on the screen of the terminal 31c. The transaction items include the item “Learning Effect”, which allows the supervisor to check the efficiency of each employee's work as a result of the learning, and the items of other transactions performed by the supervisor.

[Step S24] The control section 11 accepts a transaction request for “Learning Effect” from the terminal 31c. If an item other than the item “Learning Effect” is selected, the control section 11 performs the selected transaction.

[Step S25] The learning effect evaluation section 15 sequentially picks out the user codes of all employees stored in the learning history DB 22.

[Step S26] The learning effect evaluation section 15 determines whether or not the completion flag set with respect to the user code selected in Step S25 is “1”. Namely, the learning effect evaluation section 15 determines whether or not the learning is completed. If the set completion flag is “1”, the learning effect evaluation section 15 proceeds to Step S27; if the completion flag is not “1”, the evaluation section 15 proceeds to Step S33.

[Step S27] The learning effect evaluation section 15 acquires, from the learning history DB 22, the hierarchy number and end date and time with respect to which “1”has been set as the completion flag. Then, the learning effect evaluation section 15 obtains, from the work record DB 21, the hierarchy number associated with completed transaction work of which the hierarchy number is identical with the acquired hierarchy number and which is nearest to the acquired end date and time. Namely, the learning effect evaluation section 15 obtains, from the work record DB 21, a record of the transaction work which was started immediately after the learning and which is already completed.

[Step S28] The learning effect evaluation section 15 determines whether or not a work record (data) has been obtained from the work record DB 21 in Step S27. If a work record has been obtained, the learning effect evaluation section 15 proceeds to Step S29; if no work record has been obtained, the learning effect evaluation section 15 proceeds to Step S33.

[Step S29] The learning effect evaluation section 15 acquires, from the learning history DB 22, the hierarchy number and start date and time with respect to which “1” has been set as the completion flag. Then, the learning effect evaluation section 15 obtains, from the work record DB 21, the hierarchy number associated with completed transaction work of which the hierarchy number is identical with the acquired hierarchy number and which is nearest to the acquired start date and time. Namely, the learning effect evaluation section 15 obtains, from the work record DB 21, a record of the transaction work which was completed immediately before the learning.

[Step S30] The learning effect evaluation section 15 determines whether or not a work record has been obtained from the work record DB 21 in Step S29. If a work record has been obtained, the evaluation section 15 proceeds to Step S31; if no work record has been obtained, the evaluation section 15 proceeds to Step S33.

[Step S31] Based on the information about the obtained work records, the learning effect evaluation section 15 generates the learning effect log 23.

[Step S32] The learning effect evaluation section 15 sets “2” for the completion flag of the employee with respect to whom the learning effect log 23 has been generated.

[Step S33] The learning effect evaluation section 15 determines whether or not all of the user codes stored in the learning history DB 22 have been picked out. If all of the user codes have been checked, the evaluation section 15 proceeds to Step S34; if not, the evaluation section 15 proceeds to Step S25.

[Step S34] The learning effect evaluation section 15 determines whether or not a request to display employee-based effects has been made from the terminal 31c. If a request to display employee-based effects has been made, the learning effect evaluation section 15 proceeds to Step S35; if not, the learning effect evaluation section 15 proceeds to Step S36.

[Step S35] The learning effect evaluation section 15 displays employee-based effects on the terminal 31c. This process will be described in detail later with reference to a different flowchart.

[Step S36] The learning effect evaluation section 15 determines whether or not a request to display less effective employees has been made from the terminal 31c. If a request to display less effective employees has been made, the evaluation section 15 proceeds to Step S37; if not, the evaluation section 15 proceeds to Step S38.

[Step S37] The learning effect evaluation section 15 displays less effective employees on the terminal 31c. This process will be described in detail later with reference to a different flowchart.

[Step S38] The learning effect evaluation section 15 determines whether or not a request to display less effective teaching materials has been made from the terminal 31c. If a request to display less effective teaching materials has been made, the evaluation section 15 proceeds to Step S39; if not, the evaluation section 15 proceeds to Step S40.

[Step S39] The learning effect evaluation section 15 displays less effective teaching materials on the terminal 31c. This process will be described in detail later with reference to a different flowchart.

[Step S40] The learning effect evaluation section 15 receives a response from the terminal 31c as to termination of the transaction. If the response received from the terminal 31c is that the transaction is to be ended, the learning effect evaluation section 15 terminates the process; if the response from the terminal 31c is that the transaction is not finished, the evaluation section 15 proceeds to Step S34.

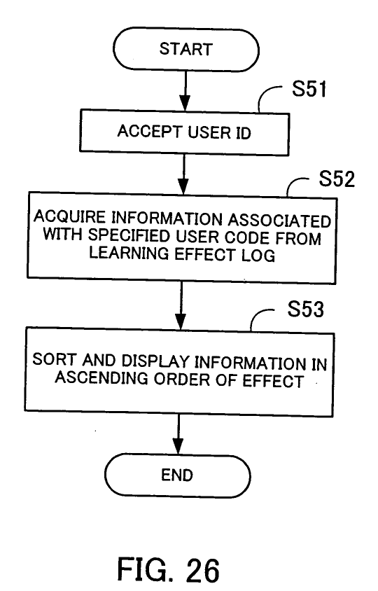

The process of displaying employee-based effects on the terminal used by the supervisor will be now described with reference to a flowchart. FIG. 26 is a flowchart showing the process executed by the transaction server when employee-based effects are to be displayed on the terminal used by the supervisor.

[Step S51] The learning effect evaluation section 15 accepts, from the terminal 31c, the user code (user ID) of an employee whose learning effects are to be displayed.

[Step S52] The learning effect evaluation section 15 acquires information associated with the accepted user code from the learning effect log 23.

[Step S53] The learning effect evaluation section 15 sorts the acquired information in ascending order of the learning effect, and displays the results on the terminal 31c.

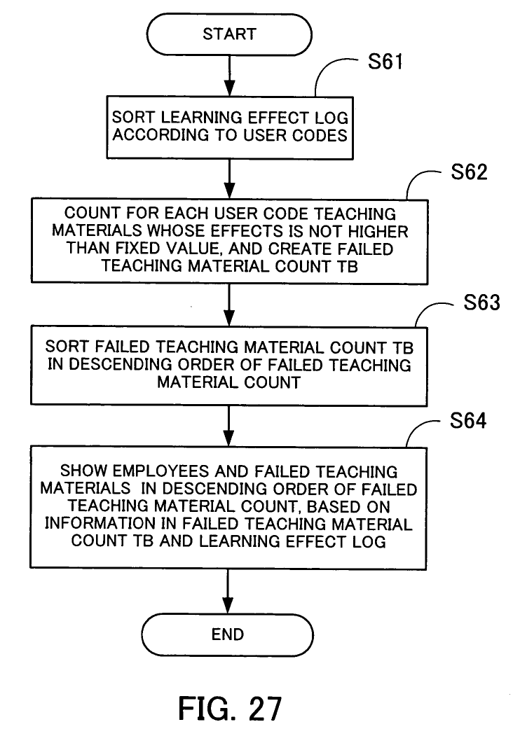

The process of displaying less effective employees on the terminal used by the supervisor will be now described with reference to a flowchart. FIG. 27 is a flowchart showing the process executed by the transaction server when less effective employees are to be displayed on the terminal used by the supervisor.

[Step S61] The learning effect evaluation section 15 sorts the learning effect log 23 according to the individual user codes.

[Step S62] The learning effect evaluation section 15 counts, for each user code in the learning effect log 23, teaching material codes of which the effect is not higher than the predetermined value, and creates the failed teaching material count TB 24.

[Step S63] The learning effect evaluation section 15 sorts the failed teaching material count TB 24 in descending order of the failed teaching material count.

[Step S64] While looking up the failed teaching material count TB 24, the learning effect evaluation section 15 displays, on the terminal 31c, employees in descending order of the failed teaching material count. Also, the evaluation section 15 looks up the learning effect log 23 and displays, on the terminal 31c, the names of teaching materials, dates of learning, etc. associated with the employees whose failed teaching material count is large.

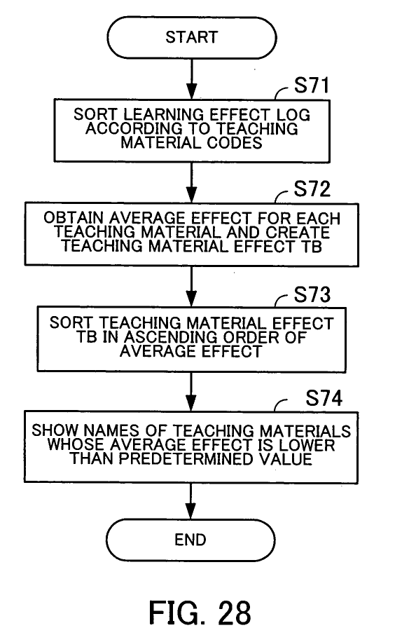

The process of displaying less effective teaching materials on the terminal used by the supervisor will be now described with reference to a flowchart. FIG. 28 is a flowchart showing the process executed by the transaction server when less effective teaching materials are to be displayed on the terminal used by the supervisor.

[Step S71] The learning effect evaluation section 15 sorts the learning effect log 23 according to the teaching material codes.

[Step S72] The learning effect evaluation section 15 obtains an average effect for each teaching material code, and creates the teaching material effect TB 25.

[Step S73] The learning effect evaluation section 15 sorts the teaching material effect TB 25 in ascending order of the average effect.

[Step S74] Based on the teaching material codes, the learning effect evaluation section 15 acquires the names of teaching materials of which the average effects are lower than the fixed value, and displays the acquired data on the terminal 31c.

In this manner, the amount of transaction work performed by each employee with the use of a terminal is stored, and also the start and end times of the employee's transaction learning are stored. Then, using the amount of work performed by the employee before the start time of the transaction learning and the amount of work performed after the end time of the transaction learning, the efficiency of the transaction work performed after the end time of the transaction learning relative to that performed before the start time of the learning is calculated. This makes it possible for a company having its employees learn about transactions to check the degree of improvement in the transaction work as a result of the transaction learning.

Also, a supervisor who supervises the transactions can specify an employee to pick out his/her working efficiency, and this makes it possible to check the degree of improvement in the transaction work performed by the individual employees.

Further, employees whose working efficiency did not reach the predetermined value can be picked out, making it possible to confirm which employees failed to improve in their transaction work even after the learning.

Moreover, by picking out learned transactions of which the working efficiency failed to reach the predetermined value, it is possible to ascertain which teaching material contents did not contribute to the improvement in the transaction work.

The processing functions described above can be performed by a computer. In this case, the processing functions to be accomplished by the transaction server 10 are described in a program recorded on a computer-readable recording medium. The program is executed by a computer, whereupon the aforementioned processes are carried out by the computer. Such a computer-readable recording medium may be a magnetic recording device, a semiconductor memory, etc. To market the program, the program may be stored on portable recording media, such as CD-ROMs (Compact Disk Read Only Memory) and flexible disks, for distribution. Alternatively, the program may be stored in the storage device of a computer connected to a network and may be transferred to other computers through the network. To execute the program by a computer, the program stored in the hard disk drive or the like of the computer is loaded into main memory and executed.

As described above, according to the present invention, the amount of transaction work which each employee has performed using a terminal is stored, and also the start and end times of the employee's transaction learning are stored. Then, using the amount of work performed by the employee before the start time of the transaction learning and the amount of work performed after the end time of the learning, the efficiency of the transaction work performed after the end time of the transaction learning relative to that performed before the start time of the learning is calculated. This makes it possible for a company having its employees learn about transactions to check the degree of improvement in the transaction work as a result of the transaction learning.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A learning program enabling a company employee to learn about transaction through a terminal device,
wherein said learning program causes a computer to perform the process of:
storing an amount of transaction work which the employee has performed using the terminal device;
displaying a learning screen on the terminal device in response to a request for transaction learning from the employee;
storing start and end times of the transaction learning which the employee has received; and
calculating, from the amount of transaction work performed before the start time of the transaction learning and the amount of transaction work performed after the end time of the transaction learning, an efficiency of the transaction work performed after the end time of the transaction learning relative to the transaction work performed before the start time of the transaction learning.

2. The learning program according to claim 1, wherein the employee whose efficiency of the transaction work is calculated is specified by a supervisor who supervises the transaction.

3. The learning program according to claim 1, wherein said learning program further causes the computer to perform the process of picking out the employee whose efficiency of the transaction work is not higher than a predetermined value.

4. The learning program according to claim 1, wherein said learning program further causes the computer to perform the process of picking out the transaction learning which failed to increase the efficiency of the transaction work up to a predetermined value.

5. The learning program according to claim 1, wherein the efficiency of the transaction work is calculated by subtracting the amount of the transaction work performed per unit time before the start time of the transaction learning from the amount of the transaction work performed per unit time after the end time of the transaction learning, and dividing an obtained difference by the amount of the transaction work performed per unit time before the start time of the transaction learning.

6. The learning program according to claim 1, wherein said learning program further causes the computer to perform the process of:
displaying a transaction screen on the terminal device to permit the employee to perform transaction; and
displaying, on the terminal device, the learning screen enabling the employee to learn about the transaction on the transaction screen when the request for the transaction learning is made from the terminal device on the transaction screen.

7. The learning program according to claim 6, wherein a learning button for requesting the transaction learning is displayed on the transaction screen.

8. A computer-readable recording medium recording a learning program enabling a company employee to learn about transaction through a terminal device,
wherein the learning program causes the computer to perform the process of:
storing an amount of transaction work which the employee has performed using the terminal device;
displaying a learning screen on the terminal device in response to a request for transaction learning from the employee;
storing start and end times of the transaction learning which the employee has received; and
calculating, from the amount of transaction work performed before the start time of the transaction learning and the amount of transaction work performed after the end time of the transaction learning, an efficiency of the transaction work performed after the end time of the transaction learning relative to the transaction work performed before the start time of the transaction learning.
